(19) United States
(12) Patent Application Publication
(10) Pub. No.: US 2013/0290088 A1
(43) Pub. Date: Oct. 31, 2013

(54) Systems and Methods for Incentive-Based Nutrition Enhancement

(71) Applicant: EDENRED USA, Newton, MA (US)

(72) Inventors: Jeremy Doak, Attleboro, MA (US); Gerard Bridi, Waban, MA (US)

(73) Assignee: EDENRED USA, Newton, MA (US)

(21) Appl. No.: 13/792,584

(22) Filed: Mar. 11, 2013

Related U.S. Application Data
(60) Provisional application No. 61/640,155, filed on Apr. 30, 2012.
(60) Provisional application No. 61/645,949, filed on May 11, 2012.

(51) Int. Cl. G06Q 30/02

(52) U.S. Cl. CPC G06Q 30/0226
USPC 705/14.27

(57) ABSTRACT

Incentivizing nutritional eating includes receiving data characterizing at least one basket level transaction for an incentivized product. The transaction is completed by a participant. Using the received data, a rating based on a measure of nutrition of the incentivized product is calculated. A reward based on the calculated rating is determined. Data characterizing the reward is provided. Related apparatus, systems, techniques, and articles are also described.

### RELATED APPLICATIONS

This application claims priority to U.S. Provisional Application No. 61/640,155 filed Apr. 30, 2012, and claims priority to U.S. Provisional Application No. 61/645,949, filed May 11, 2012, the entire contents of each of which are hereby incorporated by reference.

### TECHNICAL FIELD

The subject matter described herein relates to incentivizing consumers to purchase products that enhance their overall health through good nutrition.

### BACKGROUND

A healthy diet is one that helps maintain or improve general health. It is important for lowering many chronic health risks, such as obesity, heart disease, diabetes, hypertension and cancer. A healthy diet involves consuming appropriate amounts of all essential nutrients and an adequate amount of water. Nutrients can be obtained from many different foods, so there are numerous diets that may be considered healthy. A healthy diet needs to have a balance of fats, proteins, carbohydrates, with enough calories to support energy needs. There are a number of diets and recommendations by numerous medical and governmental institutions that are designed to promote certain aspects of health.

Employee savings programs are popular with large private and government employers. Such programs are often available for free or at a very low cost, while enhancing organizations' employee benefit package. Particularly, they improve employees' satisfaction by enabling employees to save money on the goods and services they purchase.

Merchants are ready to offer employees discounts in the range of, for example, 5% to 40% off their normal pricing to develop a new sales channel that promotes their brands in the workplace, and thus lower the cost of client acquisition and retention (other discount ranges may be used). However, current employee savings products suffer from some limitations, which imply low employee participation in such discount programs. Further, most programs only include discount offers from on-line merchants, although e-commerce represents a small fraction of total retail sales (only 3.4% in 2008 according to the US Department of Commerce).

### SUMMARY

In one aspect, incentivizing nutritional eating includes receiving data characterizing at least one basket level transaction for an incentivized product. The transaction is completed by a participant. Using the received data, a rating based on a measure of nutrition of the incentivized product is calculated. A reward based on the calculated rating is determined. Data characterizing the reward is provided.

One or more of the following features can be included. For example, the reward can be issued to the participant. The reward can be a discount on a future purchase of the incentivized product. The reward can be cash back. The reward can be determined based on at least the calculated rating and the frequency of transactions. The reward can be determined based on at least the calculated rating and the volume of the transaction. Providing data can include one or more of transmitting, persisting, and displaying. Basket level transaction data can include the identity of a product involved in the transaction. The product can be incentivized based on its nutritional value. The transaction can be between the participant and a supermarket or reseller.

Articles of manufacture are also described that comprise computer executable instructions permanently stored (e.g., non-transitorily stored, etc.) on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. In addition, methods can be implemented by one or more data processors either within a single computing system or distributed among two or more computing systems.

The subject matter described herein provides many advantages. Participants can be delivered a targeted and measurable wellness solution, which can drive end-user engagement, increase purchasing power, increase health outcomes, and reduce healthcare costs. Retailers can promote a feeling of wellness to their patrons and promote healthier store or private label options. Suppliers can target consumers more effectively, increasing traffic, sales, and image of the supplier as a socially responsible company. Employers can use the program to encourage a healthier workforce, as a recruiting tool, as a means to reduce health insurance costs, and to improve social responsibility.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method of rewarding purchases of incentivized products.

FIG. 2 is a flow diagram illustrating a sequence of events in the initial establishment and stepwise progression of an example nutritional rewards program.

FIG. 3 is a process flow diagram illustrating an employer program process.

FIG. 4 is a process flow diagram illustrating a process of providing rewards to participants.

### DETAILED DESCRIPTION

A nutritional rewards program is presented, which incentivizes the purchase and consumption of healthy foods including, for example: fruits, vegetables, whole grains, lean protein, and low fat dairy. Purchase and consumption of healthy foods will deliver measurable health outcomes including, for example, a reduction in: weight and body mass index (BMI), cholesterol, blood pressure, and sugar levels. The program encourages healthy eating and gives increased purchasing power.

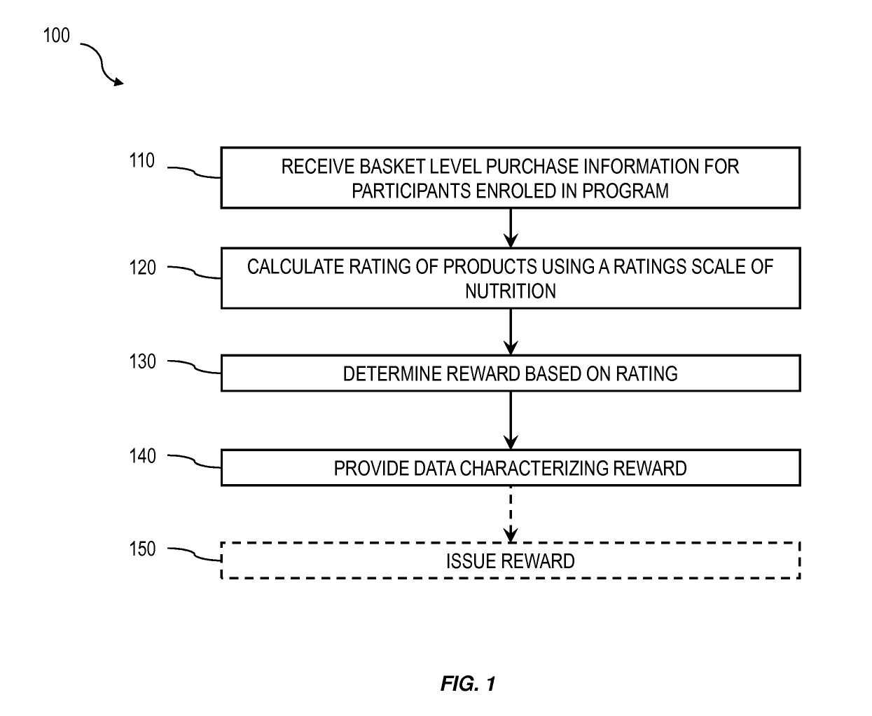

FIG. 1 is a process flow diagram illustrating a method 100 of rewarding purchases of incentivized products. At step 110, information is received regarding basket level purchases for one or more participants enrolled in the program. Participants in the program can make purchases at retailers (e.g., grocery stores, community supported agriculture (CSA), resellers such as Peapod and FruitGuy.com, etc). The received information can include details regarding specific items purchased.

At step 120, the products are rated using a rating scale. For example, the rating scale can be the NuVal® 1-100 scale developed by Yale Griffin Hospital and TopCo Associates. The rating can be based on a measure of nutrition of the products. For example, salmon fillet, which is high in nutrition, would rate under the NuVal® scale as 87 points, whereas chocolate chip cookies, which are not very nutritious, would rate as 11 points. In some implementations, the rating scale can be based on non-nutritional information (e.g., brand name, free-trade status, organic, etc.).

At 130, a reward is determined based on the calculated rating. The rewards can be discounts (e.g. coupons) on future purchases. The discounts can be on the same products. The rewards can be cash. Health plans, employers, retailers, and suppliers can fund the rewards.

At 140, data characterizing the reward can be provided. The providing can include transmitting, persisting, storing, and displaying the data. At step 150, rewards are issued to the participant based on the rating of the products purchased thereby incentivizing the product.

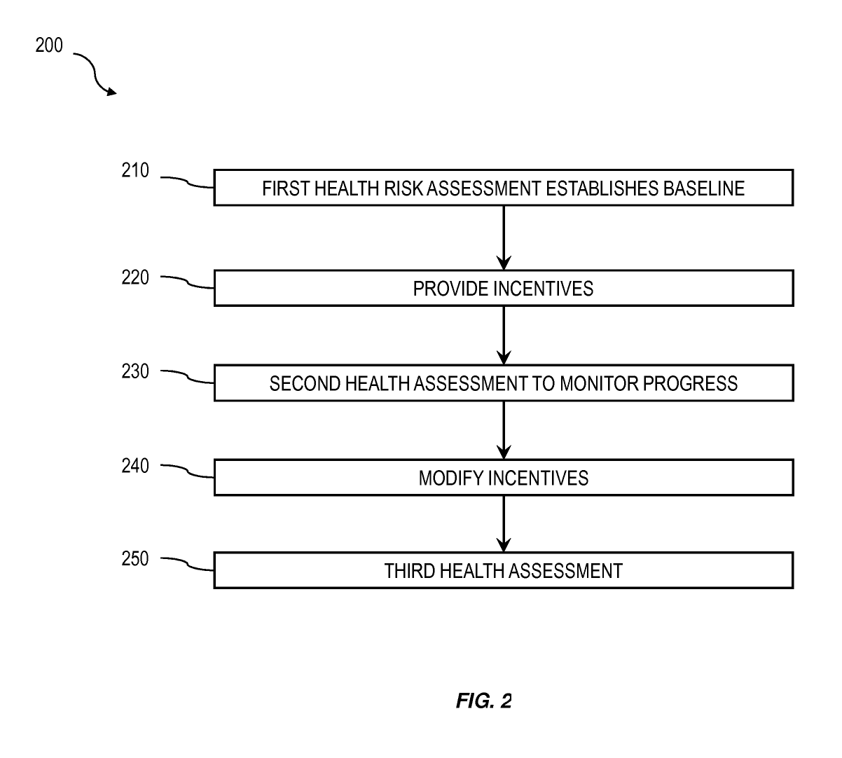

FIG. 2 is a flow diagram 200 illustrating a sequence of events in the initial establishment and stepwise progression of an example nutritional rewards program. Initially a first health risk assessment is made of participating employees (e.g., by a suitable medical facility) at 210. This establishes a baseline health level for the patient that may be used later on to determine or measure health improvements that are realized by the employee or participant involved in the program. In a second phase, the employee is given incentivized healthy eating indications by being informed that certain foods the employee may purchase are incentivized (e.g., by discounts or other benefits) at 220. In a third phase, which occurs after a suitable amount of time of presumably healthy eating by the employee, a second health assessment is made to check and report the progress of the individual level at 230. The second health assessment can be used to check and report progress on an aggregate level of all employees in the program. In one example implementation, health assessments may occur at a period of six months to one year from the beginning of the program. After the second health risk assessment, the incentivized healthy eating program may be modified to reflect further or different goals at 240. Different goals can be directed to making the employee healthier or can involve the continuation of the previous recommended food intake for the employee. Finally, a third health risk assessment may be made after a fourth period of time at 250 to determine whether the program change, if any, made after the second program phase (e.g., step 220) has resulted in the employee (or the employees in general) having a healthier status.

The program can incentivize the purchase and consumption of nutritious food. An employee may elect to participate in the program. An employee can enroll by registering one of a payment card, a shopper loyalty card and/or a prepaid card. Employees can shop as they normally would and can purchase both products that are incentivized by the program (e.g. products high in nutrition) and those which are not. The program can receive the transaction information from a retailer and rate each item purchased. The program can issue rewards such as discounts or coupons based on the score or rating of the purchased products. The employee can receive a discount on future purchases of incentivized products (e.g. products high in nutrition). For example, an employee purchasing asparagus can, through the program, receive a discount on future purchases of asparagus. The degree of discount or incentive can relate to the volume of asparagus bought or the frequency of buying asparagus.

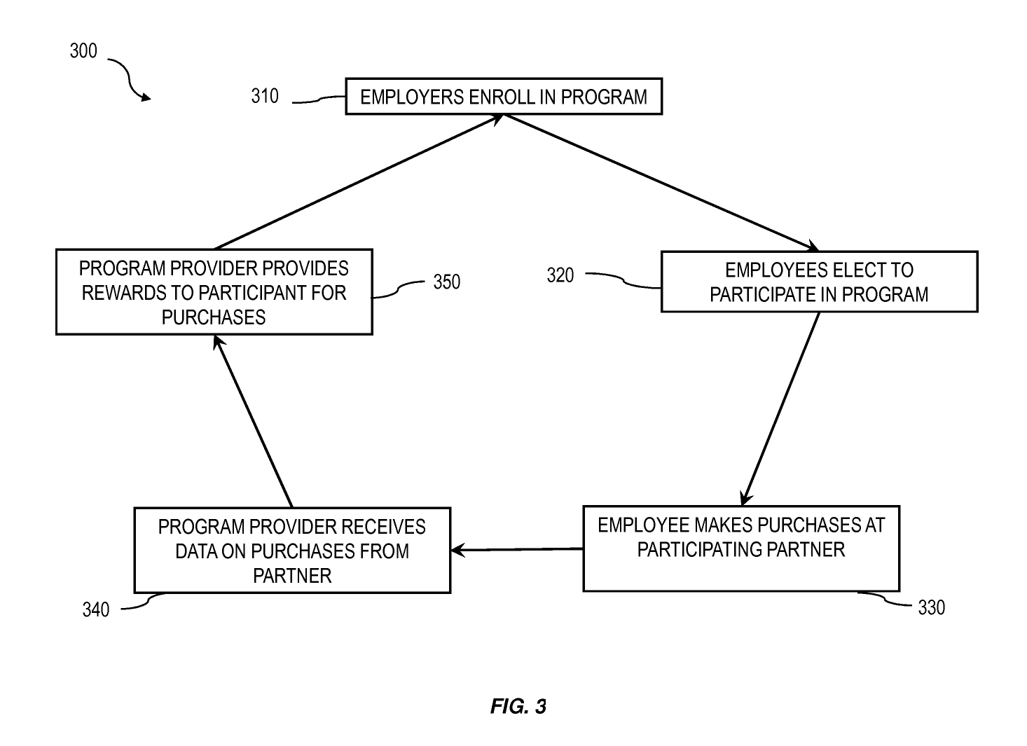

FIG. 3 is a process flow diagram 300 illustrating an employer program process. The employer program manager establishes a program at 310 by providing rewards back to participating employees for purchases of nutritional foods from selected providers. The program encourages healthy eating and gives increased purchasing power. The selected provider contracts with one or more employers to enroll the employer and its employees in the program. Employees of the employer may elect to participate in a program or may be required to participate in the program by the employer at 320. The goal, as discussed above, is to encourage healthy eating and the program does so by giving the employee increased purchasing power to purchase healthy and nutritional foods. The employee makes purchases at a participating provider/partner such as a supermarket, CSA, and reseller at 330. The provider/supermarket or other food distributing facility provides the employer program manager at 340 with data (e.g., basket level transaction data at the consumer level) of a particular employee and particular purchases made by that employee from the supermarket or other food provider. The employer program provider analyzes the data received and awards appropriate credit to the employee participant based upon his or her purchases at 350. Rewards can be distributed. The rewards can be based on points or cash back schemes for use by participants.

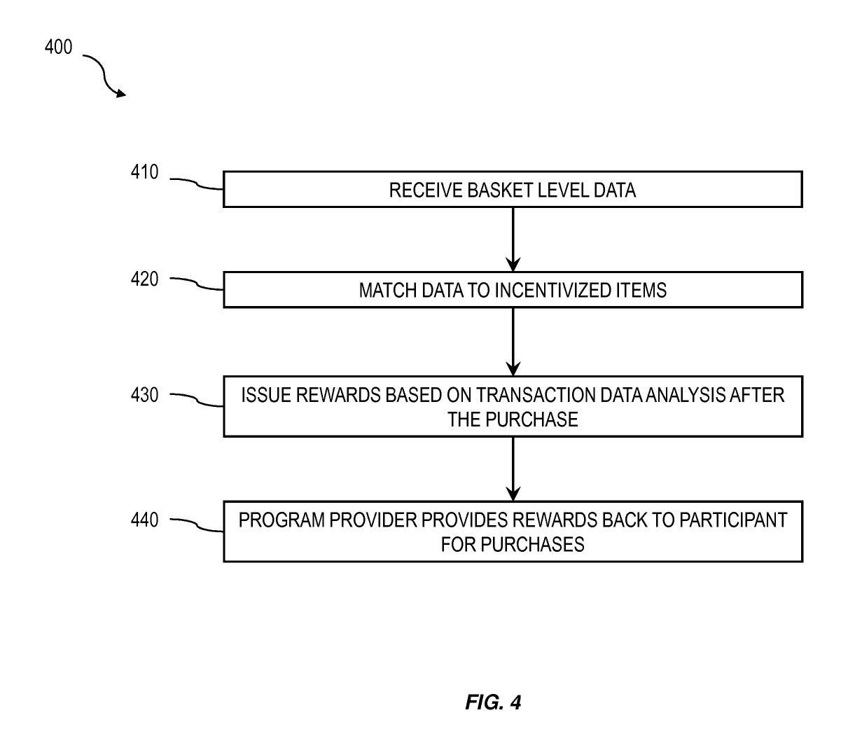

FIG. 4 is a process flow diagram 400 illustrating a process of providing rewards to participants. Purchase data (in digital format or otherwise) received by a matching data processing system at 410, which matches purchases made by an individual employee to items that are approved for incentives at 420. Data characterizing the approved items are forwarded to the employer program manager and analyzed at 430. Employees are rewarded at 440, either electronically or otherwise, for purchases based upon the rating. The rating is attributed to the purchases made by that employee.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A method of incentivizing nutritional eating comprising:
receiving data characterizing at least one basket level transaction for an incentivized product, the transaction completed by a participant;
calculating, using the received data, a rating based on a measure of nutrition of the incentivized product;
determining a reward based on the calculated rating; and
providing data characterizing the reward.

2. The method of claim 1, further comprising issuing the reward to the participant.

2. The method of claim 1, wherein the reward is a discount on a future purchase of the incentivized product.

3. The method of claim 1, wherein the reward is cash back.

4. The method of claim 1, wherein the reward is determined based on at least the calculated rating and the frequency of transactions.

5. The method of claim 1, wherein the reward is determined based on at least the calculated rating and the volume of the transaction.

6. The method of claim 1, wherein providing data includes one or more of transmitting, persisting, and displaying.

7. The method of claim 1, wherein a basket level transaction data includes the identity of a product involved in the transaction.

8. The method of claim 1, wherein the product is incentivized based on its nutritional value.

9. The method of claim 1, wherein the transaction is between the participant and a supermarket or reseller.

10. A non-transitory computer program product storing instructions, which when executed by at least one data processor of at least one computing system, implement a method comprising:
receiving data characterizing at least one basket level transaction for an incentivized product, the transaction completed by a participant;
calculating, using the received data, a rating based on a measure of nutrition of the incentivized product;
determining a reward based on the calculated rating; and
providing data characterizing the reward.

11. A system comprising:
at least one data processor;
memory storing instructions which, when executed by the at least one data processor, causes the at least one data processor to perform operations comprising:
receiving data characterizing at least one basket level transaction for an incentivized product, the transaction completed by a participant;
calculating, using the received data, a rating based on a measure of nutrition of the incentivized product;
determining a reward based on the calculated rating; and
providing data characterizing the reward.
